(19) United States
(12) Patent Application Publication
(10) Pub. No.: US 2012/0203471 A1
(43) Pub. Date: Aug. 9, 2012

(54) GENERATION SOURCE ESTIMATION APPARATUS AND METHOD OF DIFFUSION MATERIAL

(75) Inventors: Tomohiro Hara, Tokyo (JP); Shigehiro Nukatsuka, Tokyo (JP); Akiyoshi Sato, Tokyo (JP); Nobuhiro Hayakawa, Kanagawa (JP); Takeshi Adachi, Kanagawa (JP)

(73) Assignee: MITSUBISHI HEAVY INDUSTRIES, LTD., Tokyo (JP)

(21) Appl. No.: 13/434,185

(22) Filed: Mar. 29, 2012

(30) Foreign Application Priority Data
Dec. 22, 2010 (JP) 2010-286135

(51) Int. Cl. G06F 19/00

(52) U.S. Cl. 702/24

(57) ABSTRACT

A generation source estimation apparatus of a diffusion material is featured by including: an observation information acquisition section which acquires position information, and measured concentration information from each of the observers; a virtual grid setting section which sets virtual discharge points on a virtual grid; an influence function calculation section which calculates influence functions; a residual norm calculation section which calculates, for each of the virtual discharge points, a residual norm that is the sum of squares of a difference between the concentration information acquired from each of the observers, and the product of the influence function associating the virtual discharge point with each of the observers, and the discharge intensity at the virtual discharge point; and an estimation section which estimates, as a discharge point, the virtual discharge point corresponding to the residual norm smallest among the residual norms calculated respectively for all the virtual discharge points.

### TECHNICAL FIELD

The present invention relates to a generation source estimation apparatus and method of a diffusion material for estimating a generation source of a diffusion material.

### BACKGROUND ART

In response to the need for identifying a source of discharge of contaminants due to an accident, and the like, in a plant facility (a thermal power plant, a refuse incineration facility, a chemical plant, and the like), or a source of discharge of toxic gas, and the like, by terrorism, and the like, so as to immediately cope with the accident or the incident, there have been proposed various techniques about a generation source estimation apparatus and method of a diffusion material for estimating the generation source information (the position of discharge point and the discharge amount) from the site information (measured values of concentration, and the like) on the accident or the incident.

For example, in Non Patent Literature 1, a method is proposed in which the influence of an environmental impact material at each of observation points is evaluated on the basis of information, such as information on virtual discharge points and a discharge time, and in which a discharge point that minimizes the evaluation error is obtained on the basis of the variation principle, so as to identify the discharge time and amount of the environmental impact material at the discharge point.

### CITATION LIST

### Non Patent Literature

### {NPL 1}

Non Patent Literature 1: Yoshihiro Ishida, Shinsuke Kato, Kyosuke Hiyama, “Identification Technique for Environmental Impact Material based on Response Factor Method Using Sensing Information (Part 2)”, Annual Meeting of The Society of Heating, Air-Conditioning and Sanitary Engineers of Japan (September, 2009)

### SUMMARY OF INVENTION

### Technical Problem

However, the technique disclosed in Non Patent Literature 1 described above has a restriction that the number of observation points needs to be more than the number of the virtual discharge points, and hence a method is desired which can more flexibly estimate the generation source of a diffusion material.

The present invention has been made in view of the above described circumstance. An object of the present invention is to provide a generation source estimation apparatus and method of a diffusion material, capable of estimating the generation source of a diffusion material more flexibly and simply.

### Solution to Problem

In order to solve the above described problems, the present invention adopts the following solutions.

A generation source estimation apparatus of a diffusion material, according to a first aspect of the present invention, is a generation source estimation apparatus of a diffusion material for estimating gas generation source information on the basis of information from a plurality of observers, and is featured by including: an observation information acquisition unit which acquires position information, and measured concentration information from each of the observers; a virtual grid setting unit which sets, as a virtual discharge point, each of crossing points of grid lines on a virtual grid having a uniform grid line spacing; an influence function calculation unit which calculates, by using a diffusion model, an influence function determined according to a relative position and time between each of the observers and each of the virtual discharge points; a residual norm calculation unit which calculates, for each of the virtual discharge points, a residual norm that is a sum of squares of a difference between the concentration information acquired from each of the observers, and a product of the influence function associating the virtual discharge point with each of the observers, and a discharge intensity at the virtual discharge point; and an estimation unit which estimates, as a discharge point, the virtual discharge point corresponding to the residual norm smallest among the residual norms calculated respectively for all the virtual discharge points.

According to the first aspect of the present invention, in which the residual norm is evaluated for each of the set virtual discharge points and then the discharge intensity that minimizes the residual norm is obtained, in which the virtual discharge point corresponding to the discharge intensity is set as the discharge position and then the discharge intensity is estimated as the discharge amount at the discharge position. Thereby, the discharge point can be estimated regardless of the restriction that “the number of observation points ≧ the number of virtual discharge points”, and hence it is possible to realize a generation source estimation apparatus of a diffusion material, capable of estimating a generation source more flexibly and simply.

Further, a generation source estimation apparatus of a diffusion material, according to the first aspect of the present invention, is featured in that the influence function calculation unit calculates the influence function on the basis of numerical diffusion calculation.

For example, in a flat ground uniform flow field, the influence function calculation unit calculates an influence function by using a diffusion model. Further, in a complex flow field, the influence function calculation unit calculates an influence function by performing numerical diffusion calculation (simulation). Thereby, it is possible to more accurately estimate a generation source of diffusion in various landforms.

Further, a generation source estimation apparatus of a diffusion material, according to the first aspect of the present invention, is featured in that the virtual grid setting unit resets, as a virtual discharge point, a position of each crossing point of grid lines on a virtual grid which includes the discharge point estimated by the estimation unit and which has a smaller grid line spacing.

According to the first aspect of the present invention, each time a virtual grid having a larger grid line spacing is narrowed down to a virtual grid having a smaller grid line spacing, virtual discharge points are reset and a generation source is estimated. Thereby, the number of virtual discharge points on one surface of a virtual grid can be significantly reduced as compared with the case where a generation source is estimated by setting virtual discharge points on one surface of a virtual grid having a smallest grid line spacing. As a result, the calculation amount required for the total processing is suppressed, so that the generation source can be estimated in a shorter time.

Further, a generation source estimation apparatus of a diffusion material, according to the first aspect of the present invention, is featured by further including a virtual discharge time setting unit which sets virtual discharge times, and is featured in that the residual norm calculation unit calculates, for each of the virtual discharge times, the residual norm for each of the virtual discharge points, and in that the estimation unit respectively estimates, as a discharge time and point, the virtual discharge time and point corresponding to the residual norm smallest among the residual norms calculated respectively for all the virtual discharge points at each of the virtual discharge times.

According to the first aspect of the present invention, even when the discharge time is not known, the virtual discharge time is set by the virtual discharge time setting unit. Therefore, it is possible to realize a generation source estimation apparatus of a diffusion material, capable of estimating a generation source more flexibly and simply.

Further, a generation source estimation apparatus of a diffusion material, according to the first aspect of the present invention, is featured in that the influence function calculation unit calculates beforehand an influence function based on a relative position and/or relative time between an assumed observer and an assumed virtual discharge point, and stores the influence function in a database.

According to the first aspect of the present invention, the calculation amount corresponding to the processing of calculating the influence function can be eliminated in such a manner that the influence functions calculated beforehand are used for the processing by referring to the database. As a result, the calculation amount required the total processing is suppressed, and the calculation time is reduced, so that the generation source can be estimated in a shorter time.

A generation source estimation method of a diffusion material, according to a second aspect of the present invention, is a generation source estimation method of a diffusion material for estimating gas generation source information on the basis of information from a plurality of observers, and is featured by including: an observation information acquisition stage of acquiring position information and measured concentration information from each of the observers; a virtual grid setting stage of setting, as a virtual discharge point, each of crossing points of grid lines on a virtual grid having a uniform grid line spacing; an influence function calculation stage of calculating, by using a diffusion model, an influence function determined according to a relative position and time between each of the observers and each of the virtual discharge points; a residual norm calculation stage of calculating, for each of the virtual discharge points, a residual norm that is a sum of squares of a difference between the concentration information acquired from each of the observers, and a product of the influence function associating the virtual discharge point with each of the observers, and the discharge intensity at the virtual discharge point; and an estimating stage of estimating, as a discharge point, the virtual discharge point corresponding to the residual norm smallest among the residual norms calculated respectively for all the virtual discharge points.

According to the second aspect of the present invention, in which the residual norm is evaluated for each of the set virtual discharge points, and then the discharge intensity that minimizes the residual norm is obtained, in which the virtual discharge point corresponding to the discharge intensity is set as the discharge position and then the discharge intensity is estimated as the discharge amount at the discharge position. Thereby, the discharge point can be estimated regardless of the restriction that “the number of observation points the number of virtual discharge points”, and hence it is possible to realize a generation source estimation method of a diffusion material, capable of estimating a generation source more flexibly and simply.

Further, a generation source estimation method of a diffusion material, according to the second aspect of the present invention, is featured in that the influence function calculation stage calculates the influence function on the basis of numerical diffusion calculation.

For example, in a flat ground uniform flow field, the influence function calculation stage calculates an influence function by using a diffusion model. Further, in a complex flow field, the influence function calculation stage calculates an influence function by performing numerical diffusion calculation (simulation). Thereby, it is possible to more accurately estimate a generation source of diffusion in various landforms.

Further, a generation source estimation method of a diffusion material, according to the second aspect of the present invention, is featured in that the virtual grid setting stage resets, as a virtual discharge point, a position of each crossing point of grid lines on a virtual grid which includes the discharge point estimated by the estimation stage and which has a smaller grid line spacing.

According to the second aspect of the present invention, each time a virtual grid having a larger grid line spacing is narrowed down to a virtual grid having a smaller grid line spacing, virtual discharge points are reset and a generation source is estimated. Thereby, the number of virtual discharge points on one surface of a virtual grid can be significantly reduced as compared with the case where a generation source is estimated by setting virtual discharge points on one surface of a virtual grid having a smallest grid line spacing. As a result, the calculation amount required for the total processing is suppressed, so that the generation source can be estimated in a shorter time.

Further, a generation source estimation method of a diffusion material according to the second aspect of the present invention, is featured by further including a virtual discharge time setting stage of setting virtual discharge times, and is featured in that the residual norm calculation stage calculates, for each of the virtual discharge times, the residual norm for each of the virtual discharge points, and in that the estimation stage respectively estimates, as discharge time and point, the virtual discharge time and point corresponding to the residual norm smallest among the residual norms calculated respectively for all the virtual discharge points at each of the virtual discharge times.

According to the second aspect of the present invention, even when the discharge time is not known, the virtual discharge time is set by the virtual discharge time setting stage. Therefore, it is possible to realize a generation source estimation method of a diffusion material, capable of estimating a generation source more flexibly and simply.

Further, a generation source estimation method of a diffusion material, according to the second aspect of the present invention, is featured in that the influence function calculation stage calculates beforehand an influence function based on a relative position and/or relative time between an assumed observer and an assumed virtual discharge point, and stores the influence function in a database.

According to the second aspect of the present invention, the calculation amount corresponding to the processing of calculating the influence function can be eliminated in such a manner that the influence functions calculated beforehand are used for the processing by referring to the database. As a result, the calculation amount required for the total processing is suppressed, and the calculation time is reduced, so that the generation source can be estimated in a shorter time.

### Advantageous Effects of Invention

The present invention has the effect that a discharge point can be estimated without the restriction on the number of observation points, and hence it is possible to realize a generation source estimation apparatus and method of a diffusion material, capable of estimating the generation source more flexibly and simply.

### BRIEF DESCRIPTION OF DRAWINGS

FIG. 1 is a figure showing a configuration of a generation source estimation apparatus of a diffusion material according to a first embodiment of the present invention.

FIG. 2 is an illustration explaining the linearity of a diffusion phenomenon.

FIG. 3 is an illustration illustrating an example of calculation of a residual norm based on a conventional method.

FIG. 4 is an illustration illustrating an example of calculation of a residual norm based on a method according to the present invention.

FIG. 5 is a flow chart explaining a generation source estimation method of a diffusion material according to the first embodiment.

FIG. 6 is a flow chart explaining a generation source estimation method of a diffusion material according to a second embodiment.

FIG. 7 is an illustration illustrating an example in which a residual norm is calculated by using an N-th virtual grid.

FIG. 8 is an illustration illustrating an example in which a residual norm is calculated by using an (N+1)th virtual grid.

### DESCRIPTION OF EMBODIMENTS

In the following, the details of first and second embodiments of a generation source estimation apparatus and method of a diffusion material, according to the present invention, will be described in order with reference to the drawings.

### First Embodiment

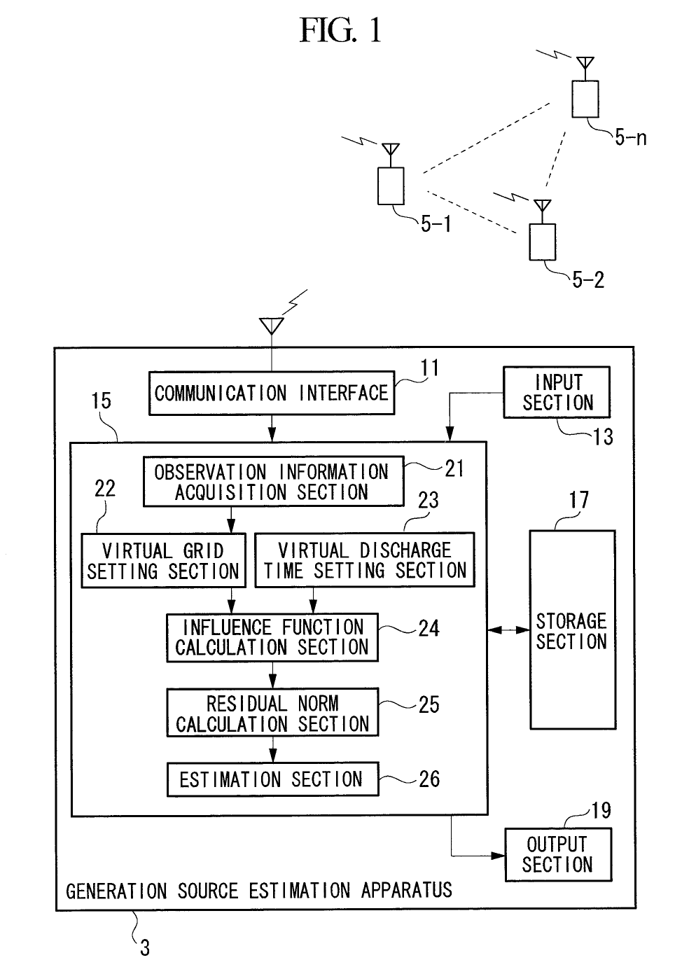

FIG. 1 is a figure showing a configuration of a generation source estimation apparatus of a diffusion material according to a first embodiment of the present invention.

In FIG. 1, a generation source estimation apparatus 3 of a diffusion material, according to the present embodiment, is configured by including a communication interface 11, an input section 13, a generation source estimation processing section 15, a storage section 17, and an output section 19. That is, the generation source estimation apparatus 3 is configured as a so-called computer system, and the generation source estimation processing section 15 is embodied by a processor, such as an MPU (microprocessor) and a DSP (digital signal processor). Further, the storage section 17 is embodied by storage devices, such as a RAM (Random Access Memory), a ROM (Read Only Memory), and an HDD (Hard Disk Drive). The input section 13 is embodied by input devices, such as a keyboard and a mouse. The output section 19 is embodied by output devices, such as a display and a printer.

Further, in FIG. 1, the generation source estimation apparatus 3 is configured to acquire, via the communication interface 11, information from n observers 5-1 to 5-n (n is a positive integer), that is, to acquire information on the positions of the observers, information on concentrations measured by the observers, and the measurement time information at the observers. Each of the observers 5-1 to 5-n includes at least a function of measuring the concentration of a desired gas in the atmosphere in the installation site, and also includes a function of periodically transmitting the information on the position of the observer, the information on the concentration measured by the observer, and the information on the measurement time. In the case where the information can be acquired from the observers 5-1 to 5-n in real time, the generation source estimation apparatus 3 may be configured so as to receive only the position information and the concentration information from the observer, and so as to substitute the reception timing on the side of the generation source estimation apparatus 3 for the information on the measurement time.

Further, each of the observers 5-1 to 5-n may be fixedly installed or movably installed. In the case where the observer is movably installed, the observer may be configured to include a GPS function so as to be able to always acquire the position information on the observer. Further, in the case where the observer is fixedly installed, an identification code (apparatus number, and the like) unique to the observer can also be substituted for the position information on the observer. In this case, on the side of the generation source estimation apparatus 3, the position information on the observer is derived on the basis of a table, and the like, in which the position information on each of the observers is associated with the identification code of each of the observers.

Further, the method for acquiring information from observation points is not limited to the method used in the configuration illustrated in FIG. 1. For example, in the case where a gas concentration observation system of a private institution or a public institution exists, and where the system includes a database function which successively accumulates the concentration data at each observation point, the method for acquiring information from observation points may also be configured to access, via the communication interface 11, the database installed on a network, such as the Internet, so as to acquire the position data of each observation point, the concentration data measured by the observer located at the each observation point, and the observation time data. From the viewpoint of immediately identifying a generation source of gas discharge, the configuration of the present embodiment (FIG. 1) is preferred.

Further, the generation source estimation processing section 15 of the generation source estimation apparatus 3 includes an observation information acquisition section 21, a virtual grid setting section 22, a virtual discharge time setting section 23, an influence function calculation section 24, a residual norm calculation section 25, and an estimation section 26. Each of these components is embodied as a functional unit of a program executed by a processor, such as an MPU and a DSP.

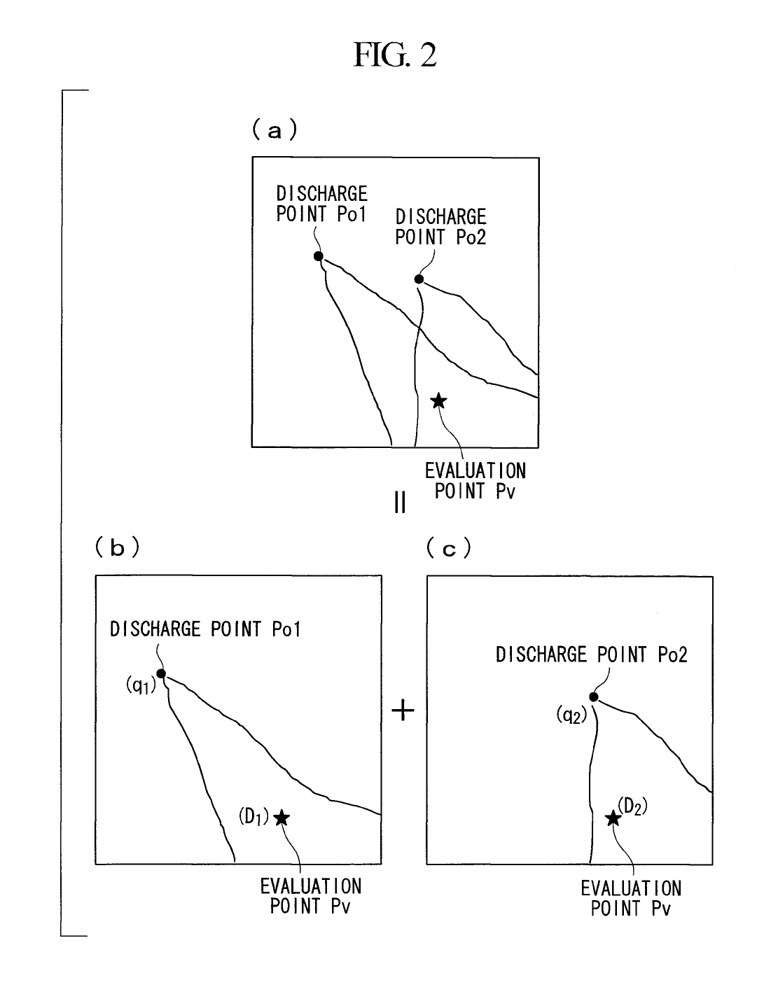

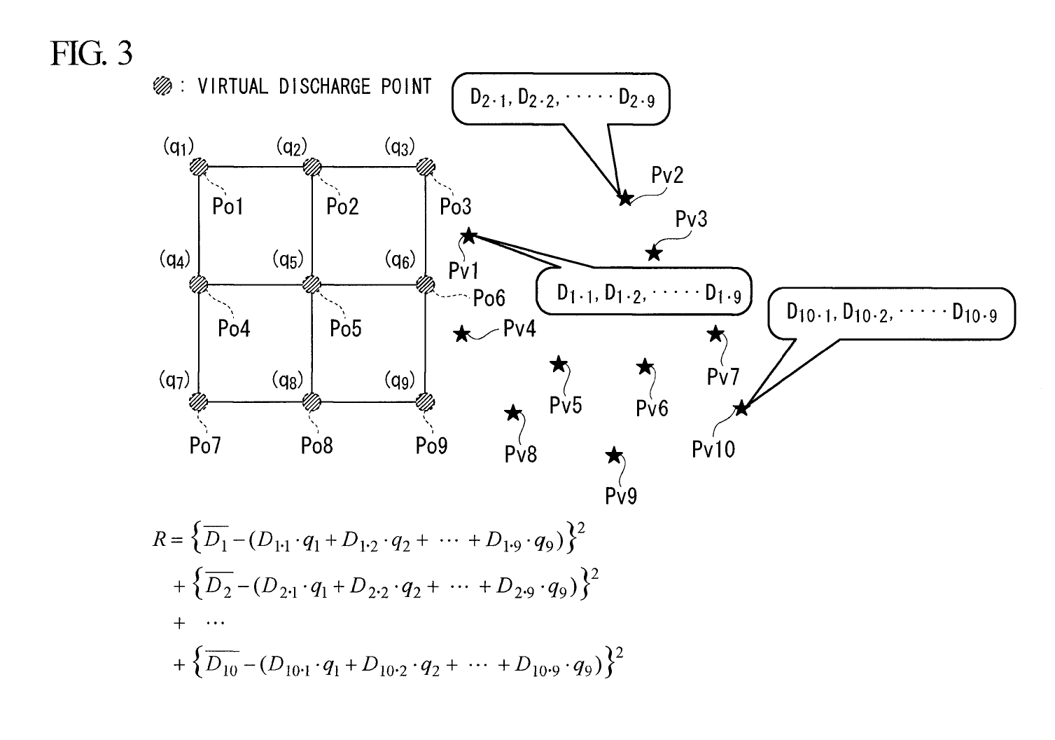

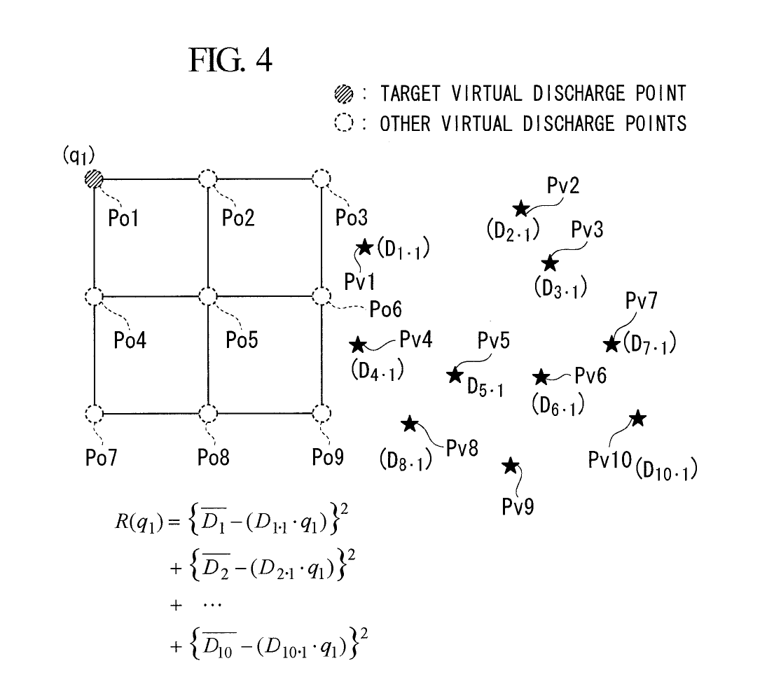

Here, before the specific function of each of the components of the generation source estimation processing section 15 is described, the basic idea of the method for estimating the generation source of a diffusion material, according to the present invention, will be described with reference to FIG. 2 to FIG. 4. FIG. 2 is an illustration explaining the linearity of a diffusion phenomenon. FIG. 3 is an illustration illustrating an example of calculation of a residual norm based on the conventional method (Non Patent Literature 1). FIG. 4 is an illustration illustrating an example of calculation of a residual norm based on a method according to the present invention.

First, the linearity which is a fundamental characteristic of the diffusion phenomenon is described. As a simple example, as shown (a) in FIG. 2, a case is considered where a diffusion material discharged from two discharge points Po1 and Po2 is observed at an evaluation point (observation point) Pv. It is assumed that uniform wind blows in the x direction in the vicinity of the discharge points, and that the direction perpendicular to the direction of the wind is the y direction (and the direction vertical to the direction of the wind and the y direction is set as the z direction).

At this time, the concentration at the evaluation point Pv is expressed by the sum of the influence of the discharge at the discharge point Po1 as shown (b) in FIG. 2, and the influence of the discharge at the discharge point Po2 as shown (c) in FIG. 2. That is, when the discharge intensities of the discharge points Po1 and Po2 are respectively set to q₁ and q₂, and when the influence functions respectively associating the discharges at the discharge points Po1 and Po2 with the evaluation point Pv are respectively set as D₁ and D₂, the concentration D at the evaluation point Pv can be expressed as “D=q₁·D₁+q₂·D₂”.

Because of such linearity of the discharge intensity in the diffusion phenomenon, when there are a plurality of discharge points (m places; m is a positive integer), the concentration D (x,y,t) at an evaluation position (x,y) and at an arbitrary time (t) is expressed by the sum of the influences due to the discharges at the respective discharge points, and hence the following expression is established.

$$\begin{matrix}\{ Expression 1 \} & \\ D ( x , y , t ) = {\sum }_{j = 1}^{m} {q}_{j} {D}_{j} ( x - {x}_{j} , y - {y}_{j} , t - {t}_{j} ) & ( 1 )\end{matrix}$$

Here, qⱼ is the discharge intensity at a discharge position (xⱼ, yⱼ), and Dⱼ(x-xⱼ, y-yⱼ, t-tⱼ) is an influence function determined by the relative position and time between the evaluation position and the discharge position.

Further, when the concentrations (D(xᵢ, yᵢ,t); i=1, 2, . . . , n) are measured at a plurality of observation points (that is, n evaluation positions (n is a positive integer)), the following expression is established.

$$\begin{matrix}\{ Expression 2 \} & \\ \overline{D} ( {x}_{i} , {y}_{i} , t ) = {\sum }_{j = 1}^{m} {q}_{j} {D}_{j} ( {x}_{i} - {x}_{j} , {y}_{i} - {y}_{j} , t - {t}_{j} ) , \\ j = 1 , 2 , , , n & ( 2 )\end{matrix}$$

Further, when the number m of discharge points is equal to or less than the number n of observation points, the discharge intensity qⱼ at each of the discharge positions (xⱼ, yⱼ) is obtained from the simultaneous equations (2). Specifically, the discharge intensity q is determined so that a residual norm, which is the sum of squares of the differences between the left side and the right side of expression (2), is minimized. The residual norm is expressed by the following expression.

$$\begin{matrix}\{ Expression 3 \} & \\ R = {\sum }_{i = 1}^{n} {\{ {\overline{D}}_{i} - {\sum }_{j = 1}^{m} {D}_{ij} {q}_{j} \}}^{2} & ( 3 )\end{matrix}$$

Further, the discharge intensity qⱼ which minimizes the residual norm is expressed by the following expression based on the variation method.

{Expression 4}

D^{T}d=D^{T}Dq; D≡Dᵢⱼ,d≡ D̅ᵢ, q≡qⱼ (4)

At this time, the residual norm is expressed by the following expression.

$$\begin{matrix}\{ Expression 5 \} & \\ \begin{matrix}R ( q ) = {q}^{T} {D}^{T} Dq - 2 {d}^{T} Dq + {d}^{T} d \\ = {d}^{T} ( d - Dq )\end{matrix} & ( 5 )\end{matrix}$$

Here, for a comparison with the method of the present invention, the conventional method (disclosed in Non Patent Literature 1) is described with reference to FIG. 3. As will be described in detail below, it is assumed that there are nine virtual discharge points (m=9) Po1 to Po9 which are respectively set at crossing points of grid lines on a virtual grid, and that there are ten observation points (n=10) Pv1 to Pv10 which are more than the number of the virtual discharge points (m=9). Further, it is assumed that the discharge intensity at the virtual discharge points Poj (j=1 to 9) are set as qⱼ (j=1 to 9), respectively.

In this case, in the conventional method, the residual norm of expression (3) is developed into the expression shown in the FIG. 3, and discharge intensities qⱼ which minimize the residual norm R in expression (3) are obtained by the variation method, or the like. Further, when the value of the discharge intensity q becomes negative in the calculation, the corresponding virtual discharge point is removed and then the calculation is again performed. Among the discharge intensities qⱼ (j=1 to 9) obtained in this way, the virtual discharge point Poj corresponding to the maximum discharge intensity qⱼ is estimated as the discharge position.

However, expression (4) essentially means that, only when all the discharge intensities qⱼ (j=1 to m) satisfying expression (4) are applied, the residual norm of expression (3) can be minimized. There is no guarantee that the residual norm of expression (3), in which only the virtual discharge point Poj corresponding to the maximum discharge intensity qⱼ in the calculation is applied, is smaller than the residual norm evaluated by applying the other virtual discharge point. This is because, although the conventional method calculates the residual norm in consideration of the influences from all the virtual discharge points and uses the expression based on the assumption that a plurality of discharge sources may exist, the virtual discharge points are finally narrowed down to one point.

On the contrary, in the present invention, the discharge intensity qⱼ that minimizes the residual norm is obtained not by solving expression (4) but by evaluating the residual norm for each of the discharge sources (that is, each of the virtual discharge points Poj (j=1 to m)), and then the virtual discharge point Poj corresponding to the discharge intensity qⱼ is estimated as the discharge position, and the discharge intensity qⱼ is estimated as the discharge amount at the discharge position.

Specifically, the residual norm for each of the virtual discharge points Poj (j=1 to m) is expressed by the following expression.

$$\begin{matrix}\{ Expression 6 \} & \\ R ( {q}_{1} ) = {\sum }_{j = 1}^{n} {\{ {\overline{D}}_{i} - {D}_{ij} {q}_{j} \}}^{2} , j = 1 , 2 , , , m & ( 6 )\end{matrix}$$

Further, the discharge intensity qⱼ which minimizes the residual norm, and the residual norm Rⱼ at that time are expressed by the following expression.

{Expression 7}

qⱼ=( D̅ᵢ·Dᵢⱼ/∥, Rⱼ=∥ D̅ᵢ∥−( D̅ᵢ·Dᵢⱼ)²/∥Dᵢⱼ∥, j=1,2, , , , m (7)

Here, description is given with reference to a calculation example of the residual norm in the present invention illustrated in FIG. 4. In FIG. 4, for comparison with the conventional method, the number of virtual discharge points and the number of observation points are set to be equal to those in FIG. 3. Further, the residual norm is calculated for each of the virtual discharge points Poj (j=1 to 9) in the present invention. In FIG. 4, the calculation of the residual norm for the virtual discharge point Po1 is illustrated as a representative example. In this case, the residual norm of expression (6) is developed into the expression shown in the FIG. 4. Similarly, the residual norm for each of the virtual discharge points Poj (j=2 to 9) is calculated, so that the discharge intensity q which minimizes the residual norm is obtained. Then, the virtual discharge point Poj corresponding to the discharge intensity qⱼ is estimated as the discharge position, and the discharge intensity qⱼ is estimated as the discharge amount at the discharge position.

Next, on the basis of the fundamental theory described above, there will be described the specific function of each of the components (that is, the observation information acquisition section 21, the virtual grid setting section 22, the virtual discharge time setting section 23, the influence function calculation section 24, the residual norm calculation section 25, and the estimation section 26) of the generation source estimation processing section 15.

First, the observation information acquisition section 21 acquires, via the communication interface 11, information from each of the observers 5-1 to 5-n, that is, the position information on the observer, the concentration information obtained by the observer, and the information on the time of measurement performed by the observer. These kinds of information are preferably stored in a predetermined region of the storage section 17 so as to be associated with each other.

Further, the virtual grid setting section 22 assumes a virtual grid having a uniform grid line spacing, and sets, as each of virtual discharge points Poj (j=1 to m), the position of each crossing point of the grid lines on the area of the virtual grid. Specifically, in the example shown in FIG. 4, nine virtual discharge points Po1 to Po9 (m=9=3×3) are set on the virtual grid. As the number m of the virtual discharge points is increased, the estimation accuracy of the discharge point is improved. To this end, the number of crossing points may be increased by reducing the grid line spacing of the virtual grid. However, the amount of calculation is increased in correspondence with the increase in the number of crossing points on the virtual grid. Therefore, it is preferred to approximate in advance the number m of the virtual evaluation points according to the required processing time (the time period from the acquisition of information from the observation points to the estimation of the discharge point), and in consideration of the processing performance, and the like, of the processor which embodies the generation source estimation processing section 15. Further, it is preferred that the area to be observed is determined on the basis of an empirical rule, and the like, and that the area of the virtual grid is set to the area to be observed.

Further, the virtual discharge time setting section 23 sets a virtual discharge time, when the discharge time is not known. That is, it is configured such that, when the discharge time is not known, a plurality of virtual discharge times are set at predetermined time intervals and then expression (7) is evaluated.

Further, the influence function calculation section 24 calculates an influence function by using a diffusion model. As described above, each of the influence functions Dᵢⱼ is a function determined according to the relative position between an evaluation point (each position of the observers 5-i (i=1 to n)), and each of the virtual discharge points Poj (j=1 to m), and the relative time (between the discharge time and the measurement time of each of the observers 5-i), and hence n×m influence functions Dᵢⱼ are calculated.

In the present embodiment, when a flat ground uniform flow field (a state where the landform of the diffusion area is a flat ground and where the flow of wind is uniform) is assumed, the puff model is used as a diffusion model. When the wind velocity is set to U [m/sec] in the puff model, the diffusion coefficient Dᵢⱼ is given by the following expression.

$$\begin{matrix}\{ Expression 8 \} & \\ {D}_{ij} ( x , y , t ) = \frac{1}{{σ}_{y} {σ}_{z}} exp ( - \frac{{( x - Ut )}^{2}}{2 {σ}_{x}^{2}} ) exp ( - \frac{{y}^{2}}{2 {σ}_{y}^{2}} ) \\ x ≡ {x}_{j} - {x}_{i} , \\ y ≡ {y}_{j} - {y}_{i} , \\ t ≡ {t}_{j} - {t}_{i} & ( 8 )\end{matrix}$$

Here, σₓ, σ_{y}, σ_{z} respectively represent diffusion parameters [m] of concentration distribution in the x, y, z directions, and are obtained on the basis of the Pasquill-Gifford diagram, an experimental expression, and the like. The diffusion model is not limited to the puff model, and other models, such as, for example, the plume model, can also be used.

Further, in many cases, the uniform flow is not obtained due to the influence of a building, a landform, and the like in a general urban area etc. In such case of complex flow field, the influence function is calculated by the numerical diffusion calculation. That is, in the case of the discharge of unit intensity from an assumed discharge point, the concentration (that is, influence coefficients) at evaluation points are obtained by using various simulation models. The simulation models include, for example, a corrected plume model, a potential flow model, and a viscous flow model. The details of the models are disclosed in, for example, “Development of numerical simulation models on gas diffusion”, Mitsubishi Heavy Industries Technical Report, September, 1984, vol. 21, No. 5, pp. 1-8. Further, it is also possible to obtain the concentration at evaluation points by using the plume/puff model described in detail in “Total Emission of Nitrogen Oxides Manual” by Air Quality Management Division, Environmental Management Bureau, Environment Agency, Japan, and also by using the particle in-cell method and the Lagrangian particle model which are also known models. In the numerical diffusion calculation, as long as the number m of virtual discharge point is, for example, about 25 (=5×5), the load in terms of calculation time is small and has little influence on the total amount of calculation.

In the case where the discharge time is not known and where a plurality of (the r number of) virtual discharge times are set by the virtual discharge time setting section 23, it is necessary to calculate the n×m×r number (r is a positive integer) of influence functions Dᵢⱼ. Therefore, in the case of a complex flow field, it is also considered that, depending on the number m of the virtual discharge points and the number r of the virtual discharge times, the influence of the amount of calculation of the influence functions on the total amount of calculation becomes large. In such case, it is preferred that, instead of performing the calculation processing one by one after acquisition of the observation information, the influence functions Dᵢⱼ are calculated beforehand at each relative time for the virtual grid (virtual discharge points Poj) of each area which can be assumed, and that the influence functions Dᵢⱼ are registered in an influence function database. Here, the data of the influence function database are stored in the storage section 17. Thereby, the influence of the processing of calculating the influence functions on the total calculation amount can be almost eliminated.

Further, the residual norm calculation section 25 calculates, for each of the virtual discharge points Poj, a residual norm Rⱼ which is the sum of squares of differences between the concentration information obtained from each of the observers 5-i (i=1 to n), and a product of the influence function Dᵢⱼ associating the virtual discharge point Poj with the each of the observers 5-i, and the discharge intensity qⱼ at the virtual discharge point Poj. That is, on the basis of expression (6), the residual norm calculation section 25 calculates the residual norm Rⱼ for each of the virtual discharge points Poj set by the virtual grid setting section 22. When the discharge time is not known and when a plurality of virtual discharge times are set by the virtual discharge time setting section 23, the residual norm calculation section 25 calculates the residual norm for each of the virtual discharge times.

Further, the estimation section 26 obtains the discharge intensity qⱼ corresponding to the residual norm smallest among the residual norms calculated respectively for all the virtual discharge points Poj. Then, the estimation section 26 sets, as the discharge position, the virtual discharge point Poj corresponding to the discharge intensity qⱼ and estimates the discharge intensity qⱼ as the discharge amount at the discharge position. When the discharge time is not known and when a plurality of virtual discharge times are set by the virtual discharge time setting section 23, the estimation section 26 further obtains the intensity qⱼ corresponding to the residual norm smallest among the minimum residual norms obtained for each of the plurality of virtual discharge times, and sets, as the discharge position, the virtual discharge point Poj corresponding to the smallest discharge intensity qⱼ. Further, the estimation section 26 estimates the smallest discharge intensity qⱼ as the discharge amount at the discharge position, and sets the corresponding virtual discharge time as the discharge time.

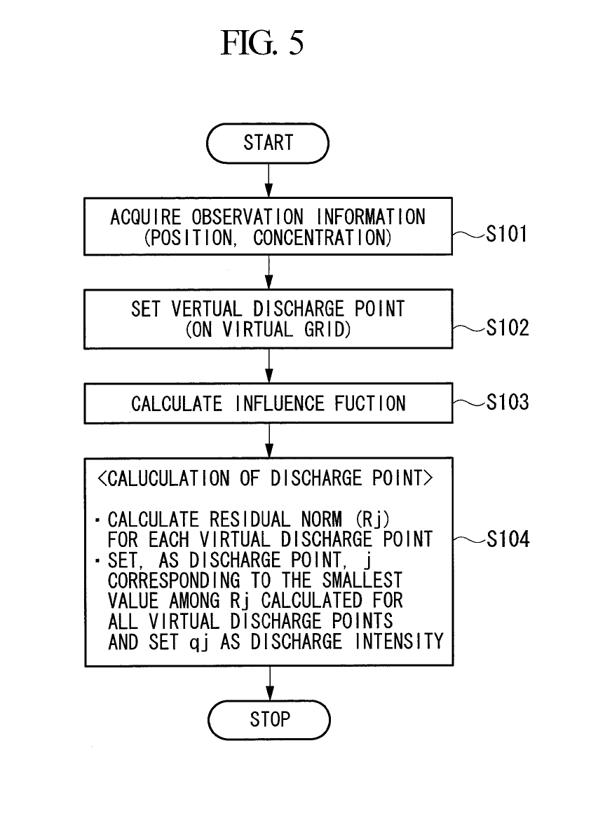

Next, the generation source estimation method of a diffusion material, which is applied in the generation source estimation apparatus 3 including the components described above, will be described with reference to FIG. 5. Here, FIG. 5 is a flow chart explaining a generation source estimation method of a diffusion material according to the present embodiment.

First, in step S101, the observation information acquisition section 21 acquires, via the communication interface 11, the position information on each of the observers 5-i (i=1 to n), and the concentration and measurement time information obtained by each of the observers 5-i.

Next, in step S102, the virtual grid setting section 22 assumes a virtual grid having a uniform grid line spacing and sets, as a virtual discharge point Poj (j=1 to m), the position of each crossing point of the grid lines on the area of the virtual grid. Here, when the discharge time is not known, the virtual discharge time setting section 23 sets virtual discharge times.

Next, in step S103, the influence function calculation section 24 calculates the influence function Dᵢⱼ by using a diffusion model (for example, expression (8)). When the virtual discharge times are set by the virtual discharge time setting section 23, the influence function calculation section 24 calculates the influence function Dᵢⱼ for each relative time corresponding to each of the virtual discharge times. Further, when the influence function Dᵢⱼ is registered beforehand in the influence function database as described above, the influence function Dᵢⱼ may also be acquired by referring to the influence function database.

Next, in step S104, on the basis of expression (6), the residual norm calculation section 25 calculates the residual norm Rⱼ for each of the virtual discharge points Poj set by the virtual grid setting section 22. When a plurality of virtual discharge times are set by the virtual discharge time setting section 23, the residual norm calculation section 25 calculates the residual norm Rⱼ for each of the virtual discharge times.

Further, in step S104, the estimation section 26 obtains the discharge intensity qⱼ corresponding to the residual norm smallest among the residual norms calculated respectively for all the virtual discharge points Poj. Then, the estimation section 26 sets, as the discharge position, the virtual discharge point Poj corresponding to the discharge intensity qⱼ, and estimates the discharge intensity qⱼ as the discharge amount at the discharge position. When a plurality of virtual discharge times are set by the virtual discharge time setting section 23, the estimation section 26 further obtains the discharge intensity qⱼ corresponding to the residual norm smallest among the minimum residual norms respectively obtained for the plurality of virtual discharge times, and sets, as the discharge position, the virtual discharge point corresponding to the discharge intensity qⱼ. Further, the estimation section 26 estimates the discharge intensity qⱼ as the discharge amount at the discharge position, and estimates the corresponding virtual discharge time as the discharge time.

As described above, the generation source estimation apparatus and method of a diffusion material, according to the present embodiment, are configured such that the observation information acquisition section 21 acquires the position information on each of the observers 5-i (i=1 to n) and the concentration information obtained by each of the observers 5-i, such that the virtual grid setting section 22 respectively sets, as virtual discharge points Poj (j=1 to m), crossing points of grid lines on a virtual grid having a uniform grid line spacing, such that the influence function calculation section 24 calculates, by using a diffusion model, an influence function Dᵢⱼ which is determined by the relative position and time between the observer 5-i and the virtual discharge point Poj, such that the residual norm calculation section 25 calculates, for each of the virtual discharge points Poj, the residual norm Rⱼ which is the sum of squares of a difference between the concentration information acquired from each of the observers 5-i, and the product of the influence function Dᵢⱼ associating the virtual discharge point Poj with each of the observers 5-i, and the discharge intensity qⱼ at the virtual discharge point Poj, and such that the estimation section 26 estimates, as the discharge point, the virtual discharge point corresponding to the residual norm smallest among the residual norms calculated respectively for all the virtual discharge points.

In this way, the residual norm R(qⱼ) is evaluated for each of the set virtual discharge points Poj, and the discharge intensity, which minimizes the residual norm R(q), is obtained. Then, the virtual discharge point corresponding to the discharge intensity is estimated as the discharge position, and further, the discharge intensity is estimated as the discharge amount at the discharge position. Therefore, the discharge point can be estimated regardless of the restriction that “the number of observation points the number of virtual discharge points”, unlike the conventional case where the discharge point needs to be estimated under the restriction. Thereby, it is possible to realize a generation source estimation apparatus and method of a diffusion material, capable of estimating a generation source more flexibly and simply.

Further, since the generation source estimation apparatus and method of a diffusion material, according to the present embodiment, is configured such that, in a flat ground uniform flow field, the influence function is calculated by using a diffusion model, such as a puff model, and such that, in a complex flow field, the influence function is calculated, by numerical diffusion calculation (simulation), as a concentration at an evaluation point at the time when the discharge of unit intensity is performed from an assumed discharge point, it is possible to more accurately estimate a generation source of diffusion in various landforms.

Further, the generation source estimation apparatus and method of a diffusion material, according to the present embodiment, is configured such that, when the discharge time is not known, the virtual discharge time setting section 23 sets virtual discharge times, it is possible to realize a generation source estimation apparatus and method of a diffusion material, capable of estimating a generation source more flexibly and simply.

Further, the generation source estimation apparatus and method of a diffusion material, according to the present embodiment, is formed to have a configuration (procedure) in which, by referring to the influence function database, the influence function calculation section 24 acquires the influence function calculated beforehand, and enables the obtained influence function to be used for the subsequent processing. Thereby, it is possible to eliminate the calculation amount corresponding to the calculation of the influence function. As a result, the calculation amount required for the total processing is suppressed, so that the generation source can be estimated in a shorter time.

### Second Embodiment

Next, a generation source estimation apparatus and method of a diffusion material, according to a second embodiment of the present invention, will be described. The configuration of the generation source estimation apparatus of a diffusion material, according to the present embodiment, is the same as the configuration of the first embodiment (see FIG. 1), and hence the detailed description of each of the components is omitted.

However, the virtual discharge points Poj (j=1 to m) are set on one surface of the virtual grid in the first embodiment, but the present embodiment is different in that the virtual discharge points PoNj (N=1 to s, j=1 to p; p is a positive integer and p<m) are set on each surface s of virtual grids (s is a positive integer and the grid line spacing is constant on the surface of each of the virtual grids), and in that the grid line spacing of the virtual grids is changed stepwise. It is assumed that the surfaces of the virtual grids are applied stepwise from a virtual grid having a larger grid line spacing to a virtual grid having a smaller grid line spacing, and that a surface of the s-th virtual grid is a surface of the smallest grid (having the smallest grid line spacing).

Further, in the present embodiment, it is assumed that, for the virtual grid (virtual discharge point PoNj) for each assumed area, the influence function calculation section 24 calculates the influence functions Dᵢⱼ beforehand for each relative time, and that the influence functions Dᵢⱼ are registered in the influence function database 18, and the data of the influence functions Dᵢⱼ are stored in the storage section 17.

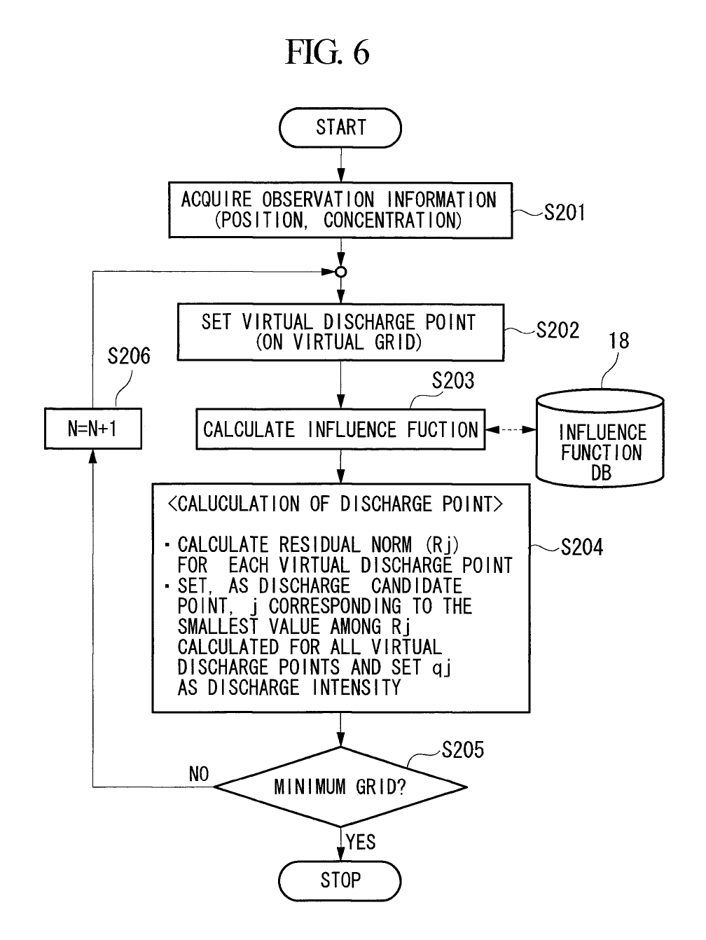

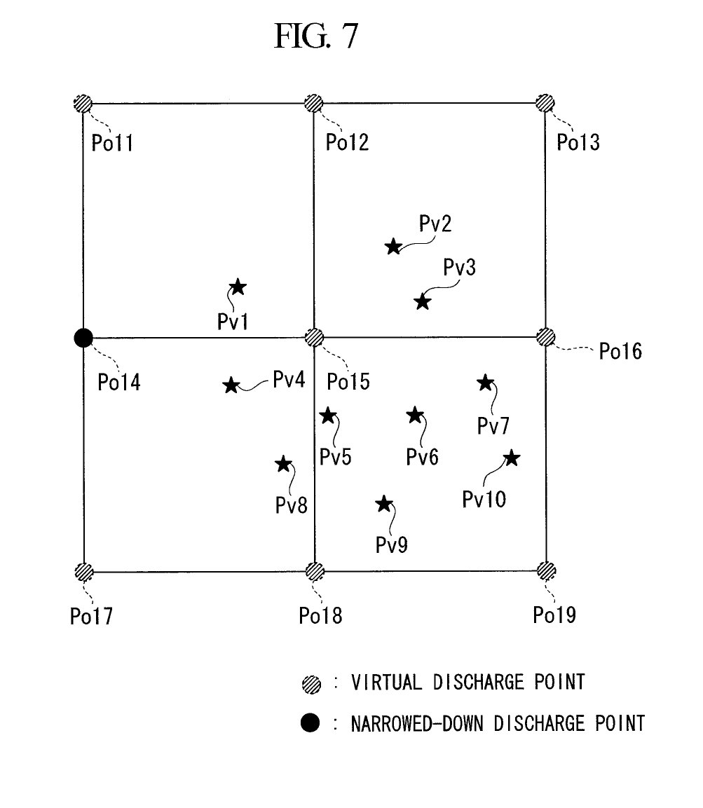

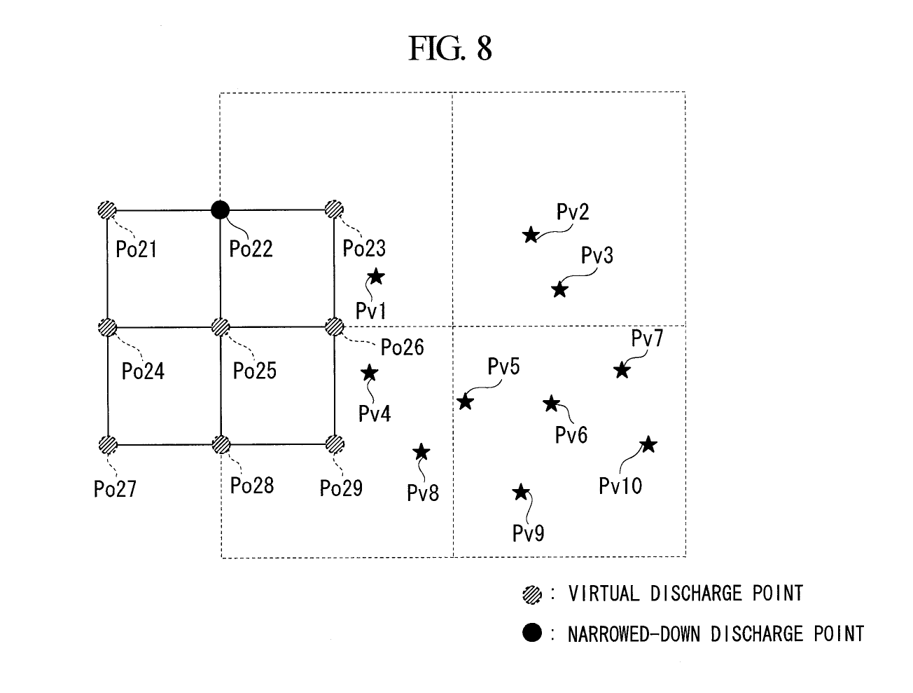

Next, the generation source estimation method of a diffusion material, according to the present embodiment, will be described with reference to FIG. 6 to FIG. 8. Here, FIG. 6 is a flow chart explaining a generation source estimation method of a diffusion material according to the present embodiment. FIG. 7 is an illustration illustrating an example in which a residual norm is calculated by using the N-th virtual grid. FIG. 8 is an illustration illustrating an example in which a residual norm is calculated by using the (N+1)th virtual grid.

First, in step S201, the observation information acquisition section 21 acquires, via the communication interface 11, the position information on each of the observers 5-i (i=1 to n), and the concentration and measurement time information obtained by each of the observers 5-i.

Next, in step S202, the virtual grid setting section 22 assumes the N-th virtual grid and sets, as the virtual discharge point PoNj (N=1 to s, j=1 to p), the position of each of the crossing points of grid lines on the virtual grid. Here, when the discharge time is not known, the virtual discharge time setting section 23 sets virtual discharge times.

Next, in step S203, the influence function calculation section 24 acquires the influence functions Dᵢⱼ by referring to the influence function database 18.

Next, in step S204, the residual norm calculation section 25 calculates the residual norm R on the basis of expression (6) for each of the virtual discharge points PoNj set by the virtual grid setting section 22. When a plurality of virtual discharge times are set by the virtual discharge time setting section 23, the residual norm calculation section 25 calculates the residual norms Rⱼ for each of the set virtual discharge times.

Further, in step S204, the estimation section 26 obtains the discharge intensity qⱼ corresponding to the residual norm smallest among the residual norms calculated respectively for all the virtual discharge points PoNj. Then, the estimation section 26 sets, as the position of a discharge candidate point, the virtual discharge point PoNj corresponding to the discharge intensity qⱼ, and further, estimates the discharge intensity qⱼ as the discharge amount at the discharge candidate point. When a plurality of virtual discharge times are set by the virtual discharge time setting section 23, the estimation section 26 further obtains the discharge intensity qⱼ corresponding to the residual norm smallest among the minimum residual norms respectively corresponding to the virtual discharge times, and sets, as the position of a discharge candidate point, the virtual discharge point corresponding to the discharge intensity qⱼ. Further, the estimation section 26 estimates the discharge intensity q as the discharge amount at the discharge candidate point and estimates the corresponding virtual discharge time as the discharge time.

Next, in step S205, the estimation section 26 determines whether or not the surface of the virtual grid applied at present is the surface of the minimum (s-th) grid. When the surface of the virtual grid applied at present is the surface of the minimum grid, the estimation section 26 ends the processing. When the surface of the virtual grid applied at present is not the surface of the minimum grid, the estimation section 26 proceeds to step S206 to increment N by one and then returns to step S202.

Here, a case is described in which, as shown in FIG. 7 and FIG. 8, a 3×3 virtual grid is used as the surface of the virtual grid and in which there are ten observation points (Pv1 to Pv10) respectively corresponding to the observers 5-i. First, in the case where the residual norm is calculated by using the N-th (N=1) virtual grid, the virtual grid setting section 22 sets nine virtual discharge points Po11 to Po19 as shown in FIG. 7 (step S202), then the estimation section 26 evaluates the residual norms for all the virtual discharge points Po11 to Po19. As a result, the estimation section 26 obtains a minimum residual norm for the discharge intensity q₄, and estimates, as a discharge candidate point, the virtual discharge point Po14 corresponding to the discharge intensity q₄.

When, after N is incremented by one (in step S206), the residual norm is calculated by using the (N+1)th virtual grid (N+1=2), the virtual grid setting section 22 sets nine virtual discharge points Po21 to Po29 as shown in FIG. 8 (step S202). Then, the estimation section 26 evaluates the residual norms for all the virtual discharge points Po21 to Po29. As a result, the estimation section 26 obtains a minimum residual norm for the discharge intensity q₂, and estimates, as a discharge candidate point, the virtual discharge point Po22 corresponding to the discharge intensity q₂. The (N+1)th virtual grid is set so as to include, in its surface, the virtual discharge point Po14 estimated as the discharge candidate point on the preceding (N-th) virtual grid. In FIG. 8, the virtual discharge point Po25 on the surface of the (N+1)th virtual grid is set to overlap with the discharge candidate point Po14 so that the discharge candidate point Po14 is positioned at the center of the (N+1)th virtual grid. However, the discharge candidate point Po14 need not necessarily be set to overlap with the virtual discharge point Po25 and need only be included in the surface of the (N+1)th virtual grid.

In this way, the surface of the virtual grid is applied stepwise from a virtual grid having a larger grid line spacing to a virtual grid having a smaller grid line spacing and finally to the surface of the s-th virtual grid as the smallest virtual grid (having the smallest grid line spacing). In the state where the surface of the s-th virtual grid is applied, the estimation section 26 obtains the discharge intensity qⱼ corresponding to the residual norm smallest among the residual norms for all the virtual discharge points PoNj, and estimates, as a discharge candidate point, the virtual discharge point PoNj corresponding to the discharge intensity qⱼ. The discharge candidate point estimated at this time is the discharge point.

As described above, the generation source estimation apparatus and method of a diffusion material, according to the present embodiment, is configured such that the virtual grid setting section 22 resets, as virtual discharge points, crossing points of grid lines on the virtual grid which includes the discharge point estimated, by the estimation section 26, on the applied surface of the preceding virtual grid and which has a smaller grid line spacing than the grid line spacing of the preceding virtual grid, and such that, each time a virtual grid having a larger grid line spacing is narrowed down to a virtual grid having a smaller grid line spacing, virtual discharge points are reset and the position of the generation source is estimated. Thereby, as compared with the first embodiment (in which the generation source is estimated by setting the virtual discharge points on one surface of the virtual grid having the smallest grid line spacing), the number of the virtual discharge points on one surface of the virtual grid can be significantly reduced, and hence the calculation amount required for the total processing is suppressed, and the calculation time is reduced, so that the generation source can be estimated in a shorter time.

In the above, the embodiments according to the present invention have been described in detail with reference to the drawings. However, the present invention is not limited to the embodiments described above, and design changes within a scope that does not depart from the spirit of the present invention are included in the present invention.

### REFERENCE SIGNS LIST

3 generation source estimation apparatus of diffusion material
5-1 to 5-n observer
11 communication interface
13 input section
15 generation source estimation processing section
17 storage section
18 influence function database
19 output section
21 observation information acquisition section
22 virtual grid setting section
23 virtual discharge time setting section
24 influence function calculation section
25 residual norm calculation section
26 estimation section

1. A generation source estimation apparatus of a diffusion material for estimating gas generation source information on the basis of information from a plurality of observers, the generation source estimation apparatus comprising:
an observation information acquisition unit which acquires position information, and measured concentration information from each of the observers;
a virtual grid setting unit which sets, as a virtual discharge point, each of crossing points of grid lines on a virtual grid having a uniform grid line spacing;
an influence function calculation unit which calculates, by using a diffusion model, an influence function determined according to a relative position and time between each of the observers and each of the virtual discharge points;
a residual norm calculation unit which calculates, for each of the virtual discharge points, a residual norm that is a sum of squares of a difference between the concentration information acquired from each of the observers, and a product of the influence function associating the virtual discharge point with each of the observers, and a discharge intensity at the virtual discharge point; and
an estimation unit which estimates, as a discharge point, the virtual discharge point corresponding to the residual norm smallest among the residual norms calculated respectively for all the virtual discharge points.

2. A generation source estimation apparatus of a diffusion material, according to claim 1, wherein the influence function calculation unit calculates the influence function on the basis of numerical diffusion calculation.

3. A generation source estimation apparatus of a diffusion material, according to claim 1, wherein the virtual grid setting unit resets, as a virtual discharge point, a position of each crossing point of grid lines on a virtual grid which includes the discharge point estimated by the estimation unit and which has a smaller grid line spacing.

4. The generation source estimation apparatus of a diffusion material, according to claim 1, further comprising:
a virtual discharge time setting unit which sets virtual discharge times, wherein
the residual norm calculation unit calculates, for each of the virtual discharge times, the residual norm for each of the virtual discharge points, and
the estimation unit respectively estimates, as a discharge time and point, the virtual discharge time and point corresponding to the residual norm smallest among the residual norms calculated respectively for all the virtual discharge points at each of the virtual discharge times.

5. A generation source estimation apparatus of a diffusion material, according to claim 1, wherein the influence function calculation unit calculates beforehand an influence function based on a relative position and/or relative time between an assumed observer and an assumed virtual discharge point, and stores the influence function in a database.

6. A generation source estimation method of a diffusion material for estimating gas generation source information on the basis of information from a plurality of observers, the generation source estimation method comprising:
an observation information acquisition stage of acquiring position information and measured concentration information from each of the observers;
a virtual grid setting stage of setting, as a virtual discharge point, each of crossing points of grid lines on a virtual grid having a uniform grid line spacing;
an influence function calculation stage of calculating, by using a diffusion model, an influence function determined according to a relative position and time between each of the observers and each of the virtual discharge points;
a residual norm calculation stage of calculating, for each of the virtual discharge points, a residual norm that is a sum of squares of a difference between the concentration information acquired from each of the observers, and a product of the influence function associating the virtual discharge point with each of the observers, and a discharge intensity at the virtual discharge point; and
an estimating stage of estimating, as a discharge point, the virtual discharge point corresponding to the residual norm smallest among the residual norms calculated respectively for all the virtual discharge points.

7. A generation source estimation method of a diffusion material, according to claim 6, wherein the influence function calculation stage calculates the influence function on the basis of numerical diffusion calculation.

8. A generation source estimation method of a diffusion material, according to claim 6, wherein the virtual grid setting stage resets, as a virtual discharge point, a position of each crossing point of grid lines on a virtual grid which includes the discharge point estimated by the estimation stage and which has a smaller grid line spacing.

9. A generation source estimation method of a diffusion material, according to claim 6, further comprising:
a virtual discharge time setting stage of setting virtual discharge times, wherein
the residual norm calculation stage calculates, for each of the virtual discharge times, the residual norm for each of the virtual discharge points, and
the estimation stage respectively estimates, as a discharge time and point, the virtual discharge time and point corresponding to the residual norm smallest among the residual norms calculated respectively for all the virtual discharge points at each of the virtual discharge times.

10. The generation source estimation method of a diffusion material, according to claim 6, wherein the influence function calculation stage calculates beforehand an influence function based on a relative position and/or relative time between an assumed observer and an assumed virtual discharge point, and stores the influence function in a database.

11. A generation source estimation apparatus of a diffusion material, according to claim 2, wherein the virtual grid setting unit resets, as a virtual discharge point, a position of each crossing point of grid lines on a virtual grid which includes the discharge point estimated by the estimation unit and which has a smaller grid line spacing.
